(19) United States
(12) Patent Application Publication
(10) Pub. No.: US 2005/0289617 A1
(43) Pub. Date: Dec. 29, 2005

(54) Personal versatile recorder and method of implementing and using same

(76) Inventors: Reem Safadi, Horsham, PA (US); Douglas S. Makofka, Willow Grove, PA (US); Robert M. Simons, Lansdale, PA (US); Jack M. Birnbaum, Southampton, PA (US); David E. Zeidler, Warrington, PA (US); Mark DePietro, Harleysville, PA (US); Lawrence D. Vince, Lansdale, PA (US); Thomas L. Du Breuil, Ivyland, PA (US); Salvatore Macera, Maple Glen, PA (US); Carl McGrath, Chalfont, PA (US); Raymond Bontempi, Jamison, PA (US); Donald W. Merino, Jenkintown, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/215,677

(22) Filed: Aug. 29, 2005

Related U.S. Application Data
(62) Division of application No. 09/520,968, filed on Mar. 8, 2000.

(51) Int. Cl. H04N 7/173; H04N 7/16

(52) U.S. Cl. 725/89; 725/134; 725/142

(57) ABSTRACT

A personal versatile recorder can be connected to, or integrated in, a cable television set-top terminal. The personal versatile recorder includes a central processing unit and a hard drive for mass data storage. Preferably, the personal versatile recorder has a tuner or tuners for receiving one or more transport streams from the cable system as well as analog or digital audiovisual programming. The data transport stream may encompass internet multimedia web content and associated applications to he utilized by the personal versatile recorder, Under instructions of the viewer or the agent application the central processing unit controls and facilitates various functions such as encoding, transcoding, decoding, caching, storing, playback and retrieval of any type of data or data file on the hard drive including compressed audiovisual programming content, streamed multimedia cached content, picture files, video files, audio files, HTML files, etc. for a variety of applications as described.

This is a divisional application of U.S. application Ser. No. 09/520,968 filed on Mar. 8, 2000.

### FIELD OF THE INVENTION

The present invention relates to the field of multi-media recording and playback. More specifically, the present invention relates to a personal versatile recorder for connection to a communication network, such as a broadband hybrid fiber coax (HFC) network of a cable television system. The personal versatile recorder of the present invention can be used for recording, transcoding, retrieval, and play-back of audiovisual programming and caching of either streaming data or a wide variety of multimedia data files and formats, including, but not limited to, compressed audiovisual files, HTML files, audio files, video or picture files, or any combination of the above, facilitating a wide variety of real time and non-real time applications.

### BACKGROUND OF THE INVENTION

Television is widely used in modern society as a source of both information and entertainment. Cable and satellite systems can supplement local over-the-air broadcasting to provide dozens or even hundreds of channels of programming.

The shear volume of available programming, however, can cause difficulties for a viewer. For example, two programs the viewer wishes to watch may be broadcast simultaneously. Also, a program the viewer wishes to see may be broadcast at an inconvenient time. These problems can be overcome by recording devices such as a video cassette recorder (VCR).

A VCR allows the user to record incoming audiovisual programming while watching a different channel. A VCR also allows the user to record programming on a timed program when the user is away and cannot watch desired programming. Consequently, the VCR allows the user to capture programming that would otherwise be missed so that that programming can be watched at the user's convenience.

The basic concept of the VCR has recently been extended to digital compression devices that provide even more features for managing the reception and recording of analog audiovisual programming. These products have a number of names such as personal television products, personal video recorders, video recording computers, personal television servers, etc., (“personal video recorders” hereafter). Current examples of personal video recorders include the TiVo® system made by TiVo, Inc. and the ReplayTV® system made by Reply Networks, Inc. Currently however these devices are limited to using analog off-air or cable television signals.

Personal video recorders replace the video cassette recording medium with a hard drive internal to the recorder. The personal video recorder is connected between a user's television set and that user's cable box, satellite receiver or antenna. The personal video recorder can control the channel tuned on the television, provide an interactive electronic program guide and record programming on a manual or timer-controlled basis. Additionally, the personal video recorder can buffer incoming audiovisual programming so that the viewer can pause a live television program or replay a portion of a live television program without missing any subsequent segment of the program, as long as the pause or replay does not exceed the capacity of the buffer. Similarly, the viewer can choose to record an entire program after watching it for some time, so long as the recording is started before the capacity of the buffer is exceeded.

In even more advanced features, the personal video recorder can be programmed to regularly record a user's favorite programs and then also record other programs of the same genre that the user may be interested in watching. Thus, the personal video recorder may help a user watch audiovisual programming that the user is interested in, but was not even aware of at the time it was broadcast.

While these personal video recording systems offer great advantages over conventional videocassette recorders, there are still shortcomings in the personal video recorders presently available, For example, some cable television companies are currently providing internet access in addition to digital and analog audiovisual programming over the cable television network. This internet access can be provided at speeds much faster than available over conventional phone lines, This trend is expected to continue with more and more electronic and multi media data services being provided over a single connection to the subscriber.

A connection to the internet can provide access to an incredible wealth of data, both images and sounds, video and audio. For example, the internet comprises a vast amount of web pages, which are computer files that provide text, images and/or sound elements when accessed with an appropriate computer program, e.g, a web browser. Other types of data files are also available over the internet such as audio files (e.g., MP3 files), picture files, (e.g., jpg files, .pic files, bit map files, etc.) and video files.

Additionally, audiovisual programming can be streamed, rather than transmitted in file format, from the internet or other internet caching servers. The digital programming is streamed or broadcast at compression rates selected by the programmer.

Data files or streamed content cannot be displayed or played on a monitor (or television set) unless opened with an appropriate “player,” I a, a software application designed to take the data as formatted in the file, or streamed content, and reproduce therefrom the encoded picture, music, sound, video, etc. Examples of player applications are: RealVideo®, RealAudio®, and Microsoft® Windows® Media. Consequently, personal video recorders are of no use in connecting a television set to a signal source that accesses both a cable, terrestrial or satellite television signal and the internet. Therefore, there is a need in the art for a device that can both provide the advantages of a personal video recorder while managing multimedia data in a wide variety of other possible file or streaming formats.

For live cybercasting/webcasting (streaming of audiovisual content), the content is transmitted in real time. One of the leading streaming content providers is Broadcast.com. It is the largest webcasting network on the Internet with several hundred radio channels, live events, variety programming, conferences and seminars. It continues to draw consumers and businesses alike and has become the largest broadcaster of live events with many innovative ideas for programming.

An example of a network provider for streaming video is InterVU which maintains a national network for delivering Web video and has partnerships with backbone providers to increase reliability and high bandwidth, interVU is the provider of video streaming to web sites such as CNN and MSNBC. It has also placed content distribution severs on Level3's network for both video and audio streaming of radio stations.

Webcasting, however, continues to face difficulties related to the availability of internet network bandwidth. The internet infrastructure was not designed with real time broadcasting of audiovisual content in mind. To alleviate this problem several companies have started offering load balancing and re-routing of data where bottlenecks are encountered. This allows for a distribution of web content by placing servers as close to the edge of the network as possible, e.g. on the networks of internet service providers (ISPs). Akamai Technologies and Digital Island provide content distribution services. They rely on a large number of highly distributed servers with load balancing capabilities. Probes and agents are installed throughout the network to gather information on congestion for rerouting. Mirroring and caching has been shown to increase network performance by 50% over in house solutions. iBeam Broadcasting and Edgix on the other hand use satellite as opposed to terrestrial links to broadcast streaming media.

However, there is a considerable cost associated with these solutions. And, they continually require additional expenses wherever load balancing becomes an issue in new locations. Consequently, there is a further need in the art for a method and apparatus that can alleviate the network loading, caching and transmission difficulties currently experienced in webcasting streaming audiovisual signals.

### SUMMARY OF THE INVENTION

It is an object of the present invention to meet the above-described needs and others. Specifically, it is an object of the present invention to provide a personal versatile recorder that can both provide the advantages of a personal video recorder while managing multimedia data in a wide variety of other possible file and streaming formats, Further, it is an object of the present invention to provide a method and apparatus that can alleviate the caching and transmission difficulties currently experienced in webcasting streaming audiovisual signals.

Additional objects, advantages and novel features of the invention will be set forth in the description which follows or may be learned by those skilled in the art through reading these materials or practicing the invention. The objects and advantages of the invention may be achieved through the means recited in the attached claims.

To achieve these stated and other objects, the present invention may be embodied and described as a personal versatile recorder for recording any type of data. The personal versatile recorder of the present invention is preferably integrated with a set-top terminal to share a common central processing unit; associated firmware and software, decoding and security elements, interfaces, etc., as well as a data storage device; a connection for receiving audiovisual programming; and for receiving one or more data transport streams. The same connection may serve both functions by receiving both audiovisual programming transport streams and at least one data transport stream, e.g. a cable television system interface.

The recorder may also include co-processors (e.g., encoding and decoding devices). The central processing unit (and associated firmware and software, referred to hereafter as the central processing unit), selectively controls the encoding, transcoding, recording, caching and playback or retrieval of the audiovisual programming and content (data) from the transport stream onto and from the data storage device.

The data of the data transport stream may include multimedia content of any format, including a picture file, a graphics file, a video file or an audio file, or real-time webcasting content. The data of the data transport stream may also include a web page, all of which are available if the connection for receiving the data transport stream connects the recorder to the internet.

A user interface allows the user to control the central processing unit to selectively record the audiovisual programming and the data from either transport stream. The user may program the central processing unit to record the audiovisual programming at a particular channel, date and time, The user may also use the interface to record data received or retrieved from the internet through the data transport stream.

To manage, display, play, or playback the possible types of multimedia data files, the central processing unit can also download any software needed to manage or open any type of multimedia file available over the transport stream, under access control where required. The central processing unit can also download any applications needed to play streamed content from a webcast, Consequently, the data of the data transport stream may also include software executable by the central processing unit to enable the central processing unit to stream data or manage and open any type of multimedia data file. The central processing unit can store such applications in memory or on the data storage device along with the associated data files.

The data storage device can be any type of mass data storage. The data storage device is preferably a hard drive, but could also be an optical disk or the like.

The recorder of the present invention also includes a connection for connecting the recorder to a television set for outputting the audiovisual programming or data stored on the data storage device to the television set, or a stand alone monitor (e.g., flat panel display). Thus, the user can use his or her television set to view or hear any of the programming or multimedia data acquired or stored on the data storage device. Other connections are also utilized such as 10/100 Mbps Ethernet, Universal Serial Bus (USB), or IEEE1394 digital bus for connectivity to other devices such as personal computers, digital cameras, etc.

The recorder of the present invention also preferably includes a downstream receiver and an upstream transmitter for receiving and transmitting messages for client-server communications. This bi-directional connectivity allows the user to obtain the desired multimedia data and the software necessary to use that data.

In one embodiment, the recorder of the present invention is integrated into a cable television set-top terminal. Within the set-top terminal, the connection for receiving analog or a digital audiovisual programming comprises a broadband primary tuner for tuning a selected channel from the audiovisual programming received from a cable television system, which may also contain data, such as broadcast HTML pages The signal from the cable television system also preferably carries the data transport stream. Therefore, the connection for receiving a data transport stream includes a secondary tuner for tuning the data transport stream from the signal received from the cable television system. This secondary tuner may optionally be utilized to tune a second analog or digital audiovisual programming to allow the user to watch one signal while recording another or to simultaneously watch two signals in a picture-in-picture mode.

The present invention also encompasses the method of operating the personal versatile recorder described herein. For example, the present invention encompasses a method of receiving and recording audiovisual programming and any type of multimedia data, in file form (such as local store information, email, community announcements, e-coupons, etc) or in streaming mode, with a personal versatile recorder. This is accomplished by selectively recording or transcoding the audiovisual programming or caching or recording broadcast or user requested data from either transport streams on the data storage device. Another aspect covered by the present invention allows the network operator (MSO) to offer the personal versatile recorder capabilities as a service. This is an integral part of the existing paradigm when compared to the retail paradigm. The access control of this device, as a resource, and its utility, as a service is consistent with the methods described in U.S. patent application Ser. No. 09/257,274, filed Feb. 24, 1999, and in U.S. patent application Ser. No. 09/389,107 filed Sep. 2, 1999 (both of which are incorporated herein by reference in their entireties). Additionally the access control scheme allows for content rights management, as a downloadable feature of the application software manipulating the content.

Additionally, the present invention encompasses all other applications of a personal video recorder as described above. For example, the present invention encompasses a method of offering video-on-demand over a cable television network comprising, during a designated download timeframe, by downloading a requested video-on-demand program over said cable television network to a personal versatile recorder connected to said cable television network where said program is recorded in said personal versatile recorder for playback under control of a user.

### BRIEF DESCRIPTION OF THE DRAWINGS

The accompanying functional drawings illustrate the present invention and are a part of the specification. Together with the following description, the drawings demonstrate and explain the principles of the present invention.

FIG. 1 is a block diagram of a personal versatile recorder according to the present invention.

FIG. 2 is a block diagram of the personal versatile recorder implemented as a separate unit from a corresponding set-top terminal.

### DETAILED DESCRIPTION OF THE PREFERRED EMBODIMENTS

Using the drawings, the preferred embodiments of the present invention will now be explained. These functional embodiments are illustrative and chosen for exposition of the principles of the present invention. The invention is not, however, limited to the following embodiments, as will be appreciated by those skilled in the art.

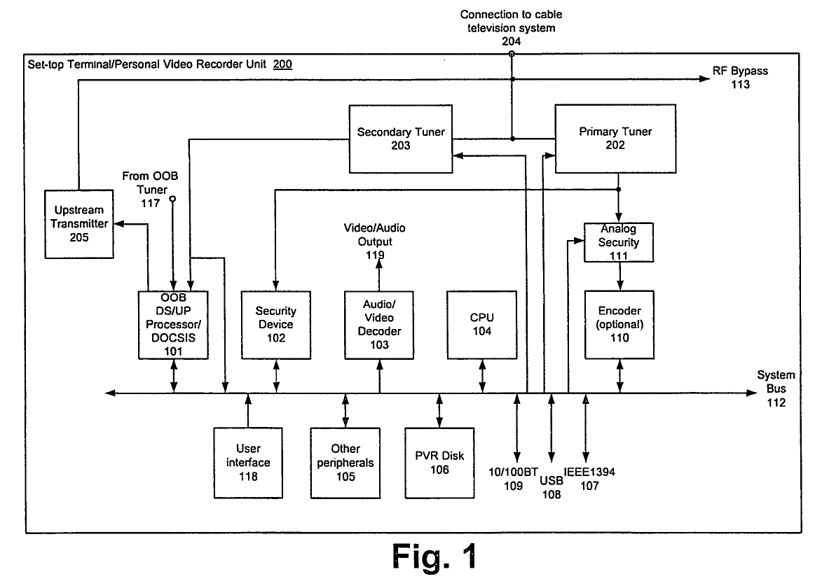

As shown in FIG. 1, the present invention preferably includes a personal versatile recording device that is integrated into a set-top terminal (200). The integrated unit (200) is a fully functional set-top terminal that performs all the functions of traditional set-top terminals to connect a user's television set to a cable television system that provides both television and other data signals, such as access to the Internet. Additionally, under the principles of the present invention, integrated unit (200) is capable of performing as a personal versatile recorder to record and playback any television programming, multimedia data files and streamed audiovisual content.

The personal versatile recording device (200) of the present invention can record and/or buffer audiovisual programming like the previous personal video recorders discussed above, e.g. transmitted as a cable television signal. The unit (200) is also capable of processing and recording digital audiovisual programming that is webcast or streamed to the unit (200), with optional real time or off-line transcoding. Additionally, the personal versatile recorder (200) of the present invention can record or cache any type of multimedia data content or files and can load and execute the associated player software required to use that cached data. As shown in the functional block diagram of FIG. 1, the personal versatile recorder according to the present invention may be integrated into a set-top terminal and use components in common with the set-top terminal. The unit (200) includes a central processing unit (CPU) (104) that interfaces with a system bus (112). The central processing unit (104), and associated firmware and software, can perform several functions, including playing and recording audiovisual programming and other multimedia data using any necessary player software, acquiring new player software, caching streamed multimedia content, executing an agent application, and transcoding streaming audiovisual data, These functions will be explained in detail below.

A personal versatile recorder disk (106), e.g., a hard drive, magneto-optical disk or the like, is connected to the system bus (112). The personal versatile recorder disk (106) provides a mass data storage medium on which the central processing unit (104) can cache or record any type of multimedia data, for example, but not limited to, incoming audiovisual programming (television broadcast or streamed webcast), video files, audio files, picture and graphics files, HTML files and the like.

As shown in FIG. 1, the set-top terminal/personal versatile recorder (200) of the present invention includes a primary tuner (202). The primary tuner (202) is preferably a broadband tuner that is used to tune a particular program offered over one of the hundreds of channels available from the cable system. The channel desired by the user is tuned using the primary tuner (202), If the television signal for that channel is an analog signal, it is then transmitted to the system bus (112) through an analog security circuit (111) for descrambling the signal, if the signal is scrambled, and, though an optional encoder (110) for hardware assisted compression. If the unit (200) is intended to process and record only digital programming, as analog transmission is phased out, the analog security (111) and the encoder (110) as illustrated are no longer necessary. Although, the encoder (110) may be retained for encoding other analog signals from alternate analog input sources for other applications.

The television programming received through the primary tuner (202) can be buffered and selectively recorded on the PVR disk (106) under the control of the central processing unit (104). This function is similar to that performed by the personal video recorders described above, The programming can also be decoded through the audio/video decoder (103) and provided to the video/audio outputs (119). The user's television set (not shown) is connected to one or more of that set of outputs (119) thereby allowing the user to watch the selected programming.

Additionally, other data may be embedded in the television signal received through the primary tuner (202). This data may include, for example, an HTML file including a link with a universal resource locator (URL) that points to a web page associated with an advertisement, for example, being shown on the television channel to which the primary tuner (202) is tuned. The central processing unit (104) will preferably be running the necessary software to extract, display and record on the PVR disk (106) any such data. If the data includes a universal resource locator (URL), the CPU (104) can access and record the file to which the URL points for subsequent review by the user. This can be done without interrupting the television programming the user is watching.

Moreover, one or more channels to which the primary tuner (202) can tune may be dedicated to providing a data transport stream. These data transport streams can carry any type of data including any type of multi-media file, streamed audiovisual content or even application software, including player software, optionally capable of contents right management, that can be stored on the personal versatile recorder disk (106) and executed by the CPU (104).

As shown in FIG. 1, the unit (200) also preferably includes a secondary is tuner (203) that is also connected to the cable television system (204). The secondary tuner (203) is used primarily to tune to the data transport stream within the signal from the cable television system (204) to free the primary tuner (202) for more conventional tuning of a television channel the user wishes to receive. This secondary tuner (203) may operate in accordance with any multiple access modems which facilitate bi-directional communication between the device and the headend, for example the Data Over Cable Service Interface Specification (DOCSIS) standard is used in this embodiment to acquire digital data. When the tuned signal facilitates bi-directional communication, e.g. is a DOCSIS signal, communication with the internet can be readily achieved so that web content may be retrievable for caching or storing in the personal versatile recorder (200). As previously stated this data may include any type of multi-media content in a variety of formats. The data transport stream from the DOCSIS tuner (203) is provided to a DOCSIS modem (101). The DOCSIS modem (101) communicates with the CPU (104) over the system bus (112).

The second purpose of the secondary tuner is to optionally allow for the respective recording and watching of separate audiovisual programming offered at two distinct frequencies, i.e., on different channels, or from different sources, i.e. streamed audiovisual content from the internet and broadcast television programming. The secondary tuner (203) can also be used in conjunction with the primary tuner (202) to simultaneously watch two different television channels or audiovisual data streams in a picture-in-picture mode. Consequently, the two-tuner configuration allows for, inter alia, the following operating modes of interest:
a) Watching an analog channel, recording a digital program (encrypted or in the clear);
b) Watching a clear digital program and recording a digital program (encrypted or in the clear);
c) Watching an encrypted program and recording an analog channel or a second digital program in the clear; and
d) Watching picture-in-picture, where the first signal is received from the primary tuner while the second is played back or retrieved from the PVR disk (106).

For cases a through d involving an encrypted MPEG-2 stream, the stream goes through the security device (102) for decryption first and then, if the decrypted signal is to be watched (instead of being recorded), it is processed by the decoder (103). The content may also be encrypted using alternate software assisted techniques, for which a second decryptor may not be required.

Digital data, multimedia files and application software, can also be transmitted to the set-top terminal over the cable television system on an out-of-band (OOB) control channel (117). Although for bandwidth capacity considerations the in-band (primary tuner) or the secondary tuner are more suitable. An OOB data channel is utilized primarily to facilitate conditional access functions for traditional and emerging services offered by the cable system operator as described in the prior art.

However received, compressed audiovisual content may then be recorded on the personal versatile recorder disk (106). If the audiovisual data is streamed, e.g. web-cast, recording that data on the disk (106) may be done for caching purposes (subsequent use by the application software on a dynamic basis) or permanently stored, Additionally, the audiovisual signal recorded on the disk (106) can be retrieved and processed through the audio/video decoder (103) and then provided to the video/audio outputs (119) of the personal versatile recorder (200). The user's television set (not shown) is connected to the video/audio outputs (119) and, consequently, receives the output signal so that the recorded audiovisual programming can then be watched by the user.

Additionally for bidirectional communication, an upstream transmitter (205) is provided in connection with the DOCSIS modem (101). The DOCSIS modem (101) incorporates an upstream processor that drives the transmitter (205) to facilitate upstream DOCSIS transmission as well as to support existing report-back protocols (101) used to manage the cable television system. The DOCSIS modem (101) thus provides bi-directional communication for internet access, user requests of web pages, files, session requests, purchase requests, etc.

Control lines to the primary tuner (202) and the secondary DOCSIS tuner (203) are provided from the system bus (112). This allows the user to input tuning commands to the system using a user interface (118) so as to control the channel tuned by the primary tuner (202). The connection to the DOCSIS tuner (203) allows the CPU (104) to control which data stream is provided to the DOCSIS modem (101) in cases where there are multiple data transport streams comprised within the signal from the cable television system (204). This is an enhancement over existing DOCSIS modem operational specifications which only allow the tuner to remain associated with the frequency assigned during the DOCSIS registration process.

The personal versatile recorder (200) may also provide an agent application. The agent is a software application, i.e., a piece of software, executed by the central processing unit (104) to automatically select and record audiovisual programming and data desired by the user as specified by parameters input by the user. For example, the agent application may monitor an electronic programming guide for television programming on interest to the user based on user-input parameters. The agent may the automatically record this programming on the PVR disk (106) for subsequent review by the user.

The agent application may also monitor and/or retrieve from internet servers any data of interest to the user based on user-input parameters. This data may include, but is not limited to, broadcast HTML pages accompanying an audiovisual advertisement or program, news files, health reports, electronic program guides, web-casts and any other data source for multimedia data that meets criteria indicated by the user. The agent application then automatically tunes and records, or acquires and caches the programming or data for later review by the user. For example, the stored advertisement HTML page may include a URL for the advertiser, where the user may get additional information at his/her convenience about the advertised product of interest without disrupting the current program viewing.

The user interface (118) allows the user to interact with and control the personal versatile recorder, For example, the interface preferably includes, for example, an application executed by the central processing unit (104) that provides display menus which can be navigated using a remote control unit (as part of the interface (118). With the user interface (118), the user is able to input commands to corresponding applications running on the central processing unit (104) to, for example, control the current or future recording of the incoming television signal from the primary tuner (202), select the desired web content to be downloaded (news, weather updates, etc.), or select other operations or set other parameters associated with an agent application.

The user interface (118) may be entirely disposed on a housing of the personal versatile recorder (200) of the present invention, although this is not preferable due to flexibility and complexity considerations. Alternatively or additionally, the user interface (118) may, as mentioned above, incorporate a remote control unit for wirelessly transmitting commands to the personal versatile recorder. The user interface (118) may comprise any control devices with which the user can input commands to the recorder, for example, a keypad, a keyboard, a microphone with voice recognition, a trackball, a joystick, knobs, dials, switches, etc.

In addition to the primary elements described above, the personal versatile recorder (200) of the present invention may also include a number of other features. For example, an RF bypass (113) offered by traditional set-top devices allows direct signal routing to the connected television set or a video cassette recorder.

Additionally, in order to interface the personal versatile recorder of the present invention with other devices and systems, a number of additional interfaces may be provided. For example, to interface a digital camera for multimedia mail applications, an IEEE1394 digital bus (107) or a Universal Serial Bus (USB) (108) may be utilized. To transfer the files to a near by PC, 10/100BT interface (109) may be utilized, etc. Connections to other peripherals such as a printer, as also shown (105).

The personal versatile recorder (200) of the present invention provides the integrated capacity to manage, record, transcode, cache, replay or retrieve multimedia data in any format including compressed analog or pre-compressed MPEG-2 digital programming, video files, image files, audio files, HTML files, text files, etc. The reception and recording of television signals is described above. Any other type of multimedia data file can be downloaded to the recorder through either tuner (202, 203) and stored on the personal versatile recorder disk (106).

Additionally, the application software necessary to retrieve or “play the multimedia files on the personal versatile recorder disk (106) can be stored on the personal versatile recorder disk (106) for use by the CPU (104). In a preferred embodiment, this application or applications would have pre-established content rights management capabilities such as those provided under the framework of the Secure Digital Music Initiative (SDMI) (incorporated herein by reference) or an analogous system. The SDMI standards include a framework to guide content management implementation in personal electronic devices, music playing software and digital music recordings to prevent or limit a user's ability to make copies of those copyrighted music recordings. If the necessary or desired application software, and associated content rights management, is not provided on the personal versatile recorder disk (106), that application software can also be downloaded through either of the aforementioned tuners (202, 203) and then stored on the personal versatile recorder disk (106) or in memory.

For example, if an image file is stored on the personal versatile recorder disk (106) or received through the DOCSIS modem (101), the CPU (104) can execute image manipulation software with which the image file can be displayed on the television set connected to the video/audio outputs (119). If a HTML file is stored on the personal versatile recorder disk (106) when received via either tuner and, the CPU (104) can activate or execute browser software, at the user's request, with which the HTML file can be displayed on the television set connected to the video/audio outputs (119). If the file contains additional URLs that the user wishes to examine, then the application uses the DOCSIS path to contact the corresponding server. Similarly, if a video or an audio file is stored on the personal versatile recorder disk (106) or received through the DOCSIS modem (101), the CPU (104) can execute a player program to provide video and/or audio signals to the television set connected to the video/audio outputs (119). If the application contains contents rights management capability, it may proceed playing or alternatively reject the content depending on what access rights the user has for this content.

If an e-mail text file is received and stored on the personal versatile recorder disk (106), the CPU (104) may execute an e-mail application to respond where the text may be displayed on the television set connected to the video/audio outputs (119) and read by the user. Although a more befitting scenario in this case is that which allows for multimedia e-mail, i.e. electronic mail that includes elements other than merely text such as pictures, graphics, audio, audiovisual, HTML files, etc.

To accommodate multimedia e-mail, the recorder of the present invention may have a connection for a microphone or a built-in microphone (105) for inputting audio to be included in a multimedia e-mail file. Additionally, a video camera may be connected via, for example, the IEEE 1394 digital bus (107) to input pictures for use in multimedia e-mail. The central processing unit (104) can acquire and execute a multimedia e-mail software program for managing these various elements and sending and receiving such multimedia e-mail.

If a microphone is connected to or built into the recorder of the present invention, it could also be utilized to facilitate voice-recognition based navigation and menu or function selection instead of relying strictly on utilizing a remote control unit of the user interface (118). For example, the central processing unit (104) may execute a voice recognition program, or a voice recognition circuit may be included in the user interface (118) to which the output of a microphone (connected or built-in) is supplied. Consequently, spoken commands may be translated into digital commands for input parameters or instructions to the recorder.

Another function performed by the personal versatile recorder of the present invention is called transcoding. When audiovisual programming is streamed to the recorder from, for example, the internet, the data of the audiovisual programming is compressed to facilitate transmission. The data must be decompressed for optimal display and compressed for storage on the disk (106). The compression and decompression of multimedia data is performed by the central processing unit (104) and is known as transcoding. Transcoding can either be performed in real-time so that MPEG-2 or streamed audiovisual programming can be displayed or stored for off-line transcoding. If transcoding is performed offline, the compression rate of the compressed stream may be varied as desired by the user to tradeoff amount of storage space required by the compressed signal v. signal quality. The user can control the transcoding performed by the recorder through the user interface (118).

The personal versatile recorder of the present invention can also be used to perform a caching function that decreases the bandwidth demands placed on the connected network and enhances data retrieval rates. For example, some web sites, content, etc. may have audiovisual elements that are always constant. Therefore, rather than downloading these elements each time that web site or the content is accessed, those constant elements can be recorded, or cached on the disk (106) of the recorder and retrieved from there. This decreases the bandwidth demand on the network and decreases the time required to provide the display desired by the user.

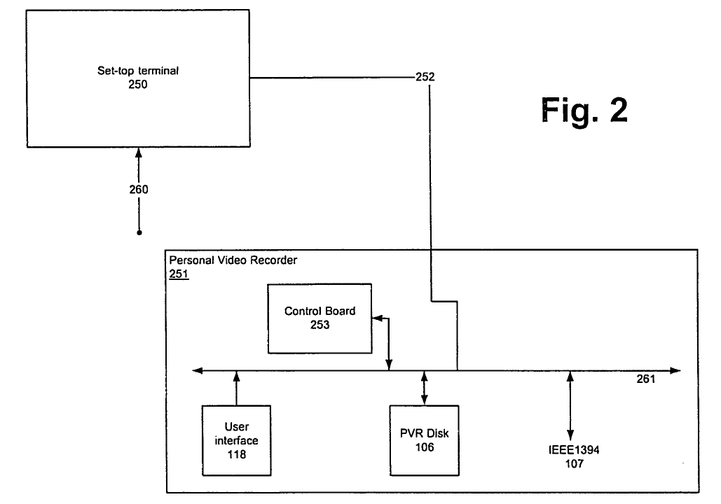

FIG. 2 illustrates an alternative embodiment of the present invention in which the personal versatile recorder of the present invention is separately housed (251). A set-top terminal (250) is connected (260) to a cable television system and is also connected (252) to a separately-housed personal video recorder (251).

The separately-housed personal versatile recorder (251) includes the PVR disk (106) for recording television programming, streamed audiovisual content and any other multi-media data files, in all other aforementioned functions in the manner described above. A control board (253) functions like the central processing unit in the embodiment of FIG. 1 to control the functions of the recorder (251). A system bus (261) provides communication between the elements of the separately-housed recorder (251).

An interface bus (252) is used to connect the recorder (251) to a set-top terminal (250). An example of this interface bus (252) is an IEEE 1394 digital bus capable of copy protection functions (e.g., Digital Transmission Content Protection (DTCP) method). Compliance with DTCP or an analogous system is necessary in the interface between the set-top terminal (250) and the personal video recorder (251) to prevent illegal copying of high value content. The separate recorder (251) may also include a user interface (118) and a second IEEE 1394 bus (107) for making other copy protected and other connections to other devices in the manner described above.

Another application of the personal versatile recorder of the present invention allows the MSO to choose to offer content in accordance with user demographics or user preferences. The content is delivered in a broadcast download manner to a group of PVRs, that belong to a given demographics/preference criteria, in an encrypted format at certain timeframes or when requested by a given user. For example, the MSO may advertise that a program or movie is offered for viewing for a certain duration, a day, a week, etc. If the viewer is interested, he/she may select the down load option and the download may be performed as a background process where the content becomes available for viewing after a specified timeframe. This is offered to the user as an item that is purchasable “on demand”. When the content is selected for viewing or playback, it is played after it has been decrypted; but while it is stored on the personal versatile recorder it remains encrypted. This also allows the user to have full motion control of the content itself as in a Video On Demand application but without having to use complex video servers at the headend or tying up network capacity for the duration of the program, instead the only network capacity used is during download. Download mechanisms of the content or associated applications (e.g., players) may is also consistent with the aforementioned applications. User preferences for multiple users with parental control access may all be stored to better control what content is retrieved and viewed.

The Personal Versatile Recorder when, coupled with content management software, provides a basis for a recorded content storage library by incorporating corresponding capabilities such as categorization and search functions, Another advantage of the Personal Versatile Recorder is its utility in storing for later retrieval network monitoring and signal quality parameters in real time. Embedded or network based trend analysis software is used to predict or detect network performance/degradation with greater granularity (per residence or per device within a residence).

The preceding description has been presented only to illustrate and describe the invention. It is not intended to be exhaustive or to limit the invention to any precise form disclosed. Many modifications and variations are possible in light of the above teaching.

The preferred embodiment was chosen and described in order to best explain the principles of the invention and its practical application. The preceding description is intended to enable others skilled in the art to best utilize the invention in various embodiments and with various modifications as are suited to the particular use contemplated. It is intended that the scope of the invention be defined by the following claims.

1. A method of offering video-on-demand over a cable television network comprising, during a designated download timeframe, downloading a requested video-on-demand program over said cable television network to a personal versatile recorder connected to said cable television network where said program is recorded in said personal versatile recorder for playback under control of a user.

2. The method of claim 1, wherein said downloading is performed as a background task.

3. The method of claim 1, wherein said downloading is performed in response to a purchase signal transmitted by a user over said cable television network.

4. The method of claim 1, further comprising transmitting a signal over said cable television network to indicate to users those programs available for downloading.

5. The method of claim 4, further comprising transmitting said signal indicative of programs available to said user selectively based on demographic or preference information concerning said users.

6. The method of claim 1, wherein said downloading further comprises recording said program on a magnetic or optical disc drive unit of said personal versatile recorder.
